(19) United States
(12) Patent Application Publication
(10) Pub. No.: US 2013/0273207 A1
(43) Pub. Date: Oct. 17, 2013

(54) Calcium Fortifying Composition for Strength, a Hydration Supplement, and Process for Preparing the Same

(71) Applicants: Pradeep Poddar, Mumbai (IN); Henry Hidell, Hingham, MA (US); C.E. Agro, Oakville (CA); Micheal Collete, Oakville (CA)

(72) Inventors: Pradeep Poddar, Mumbai (IN); Henry Hidell, Hingham, MA (US); C.E. Agro, Oakville (CA); Micheal Collete, Oakville (CA)

(21) Appl. No.: 13/825,726

(22) PCT Filed: Sep. 23, 2011
(86) PCT No.: PCT/IN11/00676

§ 371 Date: Jul. 2, 2013

(30) Foreign Application Priority Data
Sep. 23, 2010 (IN) 1071/KOL/2010

(51) Int. Cl. A23L 1/304; A23L 2/52

(52) U.S. Cl. CPC A23L 1/304; A23L 2/52
USPC 426/66; 426/74

(57) ABSTRACT

The present invention provides nutrient fortifying composition for food products and water beverages. More particularly the present invention provides calcium fortifying composition comprising calcium lactate gluconate, copper ion source, acidity regulators and class II preservative (202). The invention further provides a hydration supplement and a fortified water beverage to supplement the deficiencies of calcium in humans.

### FIELD OF INVENTION

The present invention provides nutrient fortifying composition, a hydration supplement and the process for preparing the same for the improvement of health. More particularly the invention provides Calcium fortifying composition and its use in oral snack, more particularly fortified beverages.

### BACKGROUND OF THE INVENTION

Micronutrients are nutrients needed throughout life in small quantities. They are dietary nutrients needed by the human body in very small quantities (generally less than 100 micrograms/day) as opposed to macro-minerals, which are required in larger quantities. The micro-nutrients or trace elements include at least iron, cobalt, chromium, copper, iodine, manganese, selenium, zinc, boron and molybdenum.

Due to urbanization, over population and ill practices of agriculture there are losses of essential minerals from the soil. Due to insufficient nutrients in soil there is a declination of nutrients in food, which in turn causes deficiency of nutrients among the subjects who consume such food. Some major consequences are of such deficiencies are bone disease, in every age group.

Calcium is the most abundant element in our body and has multiple critical functions. Almost all of the calcium in our body is located in our bones and teeth and essentially works as a support structure. The 1% that is not located in our bones or teeth is found in our blood, muscles and in the fluid between cells. Long-term deficiency of calcium can cause osteoporosis (the occurrence in which bones deteriorate), making you much more susceptible to fractures. Ultimately, it's an important part of a healthy diet and must be taken regularly.

A constant and consistent level of calcium should be maintained in your body fluid and tissues so that your vital body processes function efficiently. Your muscles rely on calcium to be able to contract. But calcium is not only vital to your muscles and blood vessels; it is also used during the secretion of hormones and enzymes, and is essential for the effective functioning of your nervous system.

The bones in the human body undertake continuous remodeling and restructuring, with constant re-absorption (breaking down of the bone). Calcium is deposited in your bones during this process and provides a stronger, more stable structure. Those not yet in their older years have a higher amount of bone formation with less breakdown, as opposed to aging adults (particularly women) for who bone breakdown exceeds its formation. This results in bone loss and increases the risk of acquiring osteoporosis.

Effects calcium has on performance:
1. Increases bone density
2. Enables efficient muscle contractions

Everybody should consume calcium supplements regardless of whether they are physically active or not. Calcium is good for the daily operations of your body.

Calcium is especially beneficial for weight lifters and the elderly. Weight lifters benefit from calcium by having improved muscle contractions, with a strong bone foundation that hopefully is resistant against bone breakages and fractures. The elderly, need to consume calcium specifically because of their weakening bones as they age. Without enough calcium in your body, walking down a flight of stairs can cause a fractured bone.

Several food and beverages have been provided to supplement the deficiencies of the nutrients in the human bodies.

Therefore, the object of the present invention is to provide a composition of micronutrients for fortifying food and water beverages for human consumption.

Further, the object of the present invention is to provide a micronutrient composition comprising Calcium for fortifying food for human consumptions.

Further, the object of the present invention is to provide a hydration supplement fortified with the micronutrients to supplement the deficiencies in humans.

Further, the object of the present invention is to provide treated water beverage fortified with the micronutrients to supplement the deficiencies in humans.

Further, the object of the present invention is to provide treated water fortified with calcium for strength in humans.

Further, object of the present invention is to provide the process for the preparation of the composition of micronutrients.

Further, object of the present invention is to provide the process for the preparation of the treated water beverage fortified with the micronutrients to supplement the deficiencies.

### SUMMARY OF THE INVENTION

In order to obviate the drawbacks of the prior art and to provide a suitable supplement micronutrients, the present invention provides a composition of micronutrients particularly calcium for fortifying food and water beverage for human consumption.

Therefore, the present invention provides calcium fortifying composition for strength for food and Water Beverage products. Said composition comprises:
Calcium lactate gluconate,
optionally supplemented by calcium chloride dihydrate
copper ion source,
acidity regulator (330),
class II preservative (202)

The percentage of amounts of the ingredients in the composition is as follows:
about 85.1% to 93.50% by wt Calcium lactate gluconate
optionally supplemented by about 6.5% to 7.2% by wt calcium chloride dihydrate
about 4.2% to 4.9259% by wt copper ion source
about 0.6842% to 2% by wt class II preservative (202)
about 0.8894% by wt citric acid, acidity regulator (330)

The invention further provides a hydration supplement for human consumption. Said hydration supplement comprising the calcium fortifying composition along with a suitable food or water beverage item. Further, the amount of composition in the hydration supplement is 0.039% to 0.055% by weight or about 512 mg per liter such that the amount of the calcium source ingredient in the hydration supplement is 0.041% to 0.048% by weight or about 480 mg per liter and amount of copper in the composition is 0.00216% by weight or about 22 mg per liter.

The ratio of the elemental Calcium to the Copper is maintained at 60:1 in the said composition as well as the hydration supplement.

Said hydration supplement is in liquid or semi solid or solid form. Further said hydration supplement may be a beverage such as aerated drink, treated water, etc.

The invention further provides treated water beverage fortified with Calcium composition. The fortified water comprises:
treated water prepared by the process taught in our co-pending application,
calcium fortifying composition comprising Calcium lactate gluconate, optionally Calcium Chloride, Copper ion source, acidity regulator (330), class II preservative (202).

Said water-neutral beverage provides, 50 mg to 75 mg per litre elemental Calcium and, 1 mg per litre of elemental copper. Preferably the beverage provides 60 mg of elemental Calcium.

Further the water of present invention has no added flavors or sweeteners to mask ingredient flavors.

The ingredients used in the water neutral beverage are selected in a manner as to be compatible with water such that they do not have any odour, highly soluble & do not precipitate or reacts or sediments. Also, the shelf life of the elements has been so maintained in the composition that when the composition does not degrade when used with water.

Further, the Copper from the Copper source in the composition enables cold-filling process of packaging. The filling could then be carried out without the presence of ozone in the product and also obviating the necessity of hot-fill process thereby enhancing the bio-availability of Calcium from the Calcium source in the composition.

Said effects are the result of the synergistic effect among the ingredients of the composition. The invention further provides the process for the preparation of the treated water fortified with calcium. Said process comprises treatment of source water, adding proprietary—composition in a suitable manner to get the fortified water beverage ready to fill and pack as required. The process has been designed to meet the specific requirements of the beverage of the present invention.

This process further involves effective treatment and sterilization of water without having to use harmful chemicals or long storage or heat. This on line treatment reduces the risks of the water and also provides a consistent base characteristic on which the composition can enhance to achieve the desired nutritional characteristics

### DETAILED DESCRIPTION OF THE INVENTION

The present invention provides a solution to the majority of the population in India who are deficit of various essential nutrients. The amount of different nutrients, which have been fortified, is equivalent to atleast 5 mg of elemental Calcium in the form of Calcium Lactate Gluconate, optionally 1 mg of elemental Calcium from Calcium Chloride and 0.1 mg of elemental Copper in the form of Nutribond per 100 ml of water along with Potassium Sorbate as preservative.

The purpose of the product is to provide an inexpensive source of safe nutritious drinking water having an additional quantity of dietary nutrients for the population suffering from deficiencies of these nutrients. Therefore, in order to provide an adequate amount of required nutrients for good health, nutrient fortified bottled drinking water would be a useful product for the majority of the masses.

### Functions of Calcium in Human Body

Calcium is an essential element in the human body. Although over 99% of the total body Ca is located in bone, it is a critical cation in both the extracellular and intracellular spaces. In addition to its important role in the bone mineral matrix, it also serves a vital role in
nerve impulse transmission
muscular contraction
blood coagulation
hormone secretion and
intercellular adhesion

Calcium is also an important intracellular second messenger for processes such as exocytosis, chemotaxis, hormone secretion, enzymatic activity, and fertilization. Calcium balance is tightly regulated by the interplay between gastrointestinal absorption, renal excretion, bone resorption, and the vitamin D-parathyroid hormone (PTH) system.

Scientists have discovered that the body fluids of healthy people are mildly alkaline (high pH), whereas the body fluids of the sick are acidic (low pH). Calcium is responsible for maintaining the proper body fluid pH.

### How Much Calcium Do We Need?

In order to maintain adequate calcium levels in our body for its smooth functioning, certain dietary amounts have been recommended. These are known as the Recommended Daily Allowance (RDA) or the Dietary Reference Intake (DRI). DRI values replaced RDAs and are the updated Reference Daily Intake (RDI) (http://www.crnusa.org). But in certain cases where evidence is insufficient to develop an RDA, Adequate Intakes (AI) are established at a level assumed to ensure nutritional adequacy.

The Food and Nutrition Board (FNB) has established Adequate Intakes (AIs) for the various nutrients required by a healthy body. Table 1 lists down the values for Adequate Intakes (AI) for Calcium required maintaining adequate rates of calcium retention and bone health in healthy body. There is no international consensus on what the healthiest or safest amount of calcium we need is. In the UK, the Reference Nutrient Intake (RNI) value is used, which is similar to the Recommended Daily Allowance (RDA). The UK government currently suggests that the RNI value for calcium in adults aged between 19 and 50 years of age is 700 mg per day.

In the US, the Institute of Medicine (IOM) has recommended a daily intake a slightly higher at 1000 mg per day. However, in many countries of developing world or the underdeveloped world, the average daily intake of calcium is in fact as low as 300 mg.

TABLE 1
Adequate Intakes (AIs) for Calcium (Ca) as per FNB establishment in the
year 1997

| | | Male | | | |
|---|---|---|---|---|---|
| Age | | (mg) | Female (mg) | Pregnant (mg) | Lactating (mg) |
| 0-6 | months | 210 | 210 | — | — |
| 7-12 | months | 270 | 270 | — | — |
| 1-3 | years | 500 | 500 | — | — |
| 4-8 | years | 800 | 800 | — | — |
| 9-13 | years | 1300 | 1300 | — | — |
| 14-18 | years | 1300 | 1300 | 1300 | 1300 |
| 19-50 | years | 1000 | 1000 | 1000 | 1000 |
| 50+ | years | 1200 | 1200 | — | — |

mg: milligrams

Table 2 gives a comparison of the values for Recommended Daily Allowance for Calcium as established in India by the Indian Council of Medical Research (ICMR) and USA whereas Table 3 gives a comparison of the recommendations of the various countries & WHO for Calcium intake per day. But a study conducted on the Indian Population of both genders and age groups showed that daily dietary calcium intake of both rural & urban adults and children was far below that of RDA of 600 mg/day for adults & 800 mg/day for children.

TABLE 2
Recommended Dietary Allowance (RDA mg/day) of calcium in India and
USA
Amount of calcium needed (mg/day)

| | | |
|---|---|---|
| Category | India | USA |

Infants, in months

| | | |
|---|---|---|
| 0-6 | 500 | 500 |
| 6-12 | 500 | 750 |

Children (boys & girls), in years

| | | |
|---|---|---|
| 1-9 | 600 | 800 |
| 10-15 | 800 | 1200-1300 |
| 16-18 | 800 | 1200-1300 |

Adults

| | | |
|---|---|---|
| Men | 600 | 800-1000 |
| Women | 600 | 800-1000 |
| Pregnant | 1200 | 1200-1300 |
| Lactating | 1200 | 1200-1300 |

TABLE 3
Current recommendations by various countries for calcium intake
(mg per day)

| | | | | WHO, | WHO (low |
|---|---|---|---|---|---|
| Subjects | | UK | Australia | 2004 | protein intake) |
| 0-6 | months | 525 | — | — | — |
| 7-12 | months | — | — | 400 | 450 |
| 1-3 | years | 350 | — | 500 | 500 |
| 4-6 | years | 450 | 530-800 | 600 | 550 |
| 7-9 | years | 500 | — | 700 | 700 |
| 10-18 | years | — | — | 1300 | 1000 |

| | | | | |
|---|---|---|---|---|
| Boys | 1000 | 1000-1200 | — | — |
| Girls | 800 | 800-1000 | — | — |
| Pre-menopausal women | 700 | 800 | 1000 | 750 |
| & men <65 yr | | | | |
| Menopausal women & | 700 | Women: | 1300 | 800 |
| men >65 yr | | 1000 | | |
| | | Men: 800 | | |
| Pregnancy (last trimester) | 700 | 1100 | 1200 | 800 |
| Lactation | 1250 | 1200 | 1000 | 750 |

As per a study conducted by WHO, it has been found that in certain countries the calcium intake by adults is much lower than the Indian Intake whereas in certain other countries the intake is much higher. Table 4 shows the calcium intake by adults in some of the developed countries.

TABLE 4
Reported ranges for Calcium intakes by adults in developed & the
developing countries [Data of persons weighing 70 kg]

| Country/Area | Calcium intake (mg/day) |
|---|---|
| Canada | 757-1320 |
| France | 881-1003 |
| Guam | 743-1318 |
| Indonesia | 342 |
| Israel | 548-733 |
| Japan | 660-845 |
| Malaysia | 255-333 |
| Myanmar | 498 |
| Pakistan | 508-647 |
| Philippines | 390 |
| Singapore | 482 |
| South Africa | 438-577 |
| Spain | 1267 |
| United Kingdom | 755-1267 |
| Viet Nam | 488 |
| Adult DRI | 1000-1200 |
| | (AI) |

Excessively high intakes of calcium can interfere in the absorption of zinc, magnesium, iron, and phosphorus. When calcium concentration in the human body becomes too high compared to the concentrations of magnesium, excess calcium may be deposited in the soft tissues. This may result in calcium deposits in places such as the kidneys, the arteries and the heart.

### Dietary Sources of Calcium

Milk, yogurt & cheese are rich sources of calcium. Nondairy sources include vegetables, such as Chinese cabbage, kale, and broccoli. Most grains do not have high amounts of calcium unless they are fortified; however, they contribute calcium to the diet because they do have small amounts and people consume them frequently in larger quantity. Soy beverage, calcium-fortified, 8 ounces and orange juice, calcium-fortified, 6 ounces likewise contribute about 80-500 mg and 200-260 mg per serving respectively. So we have a range of fortified food items in is the market, which will provide an appropriate amount of the calcium to the human population. The U.S. Department of Agriculture's Nutrition Database listed the nutrient content of many foods.

### Interest in Calcium Fortified Products

Along with the current developments of the overall functional food markets, the use of minerals especially calcium salts is expected to exhibit strong growth rates. Future trends include growing consumer concern regarding the deficiency diseases due to the lack of calcium such as osteoporosis and bone health, blood pressure regulation; such as hypertension and colon cancer are leading to increase the sales of calcium fortified products. Here in this report the fortification has been done in water with an organic compound Calcium Lactate Gluconate, the calcium source. A study has been conducted in France with over 4,000 women were found that consumption of calcium in their drinking water was associated with an increase in their bone density.

### Calcium Lactate Gluconate

Calcium Lactate Gluconate with molecular formula Ca₅(C₃H₅O₃)₆.(C₆H₁₁O₇)₄.2H₂O and the properties as given in Table 5 is also known as calcium lactogluconate (CLG) and is a relatively new product for Ca fortification in food and beverages. It is derived from commonly used calcium sources, calcium lactate and Ca gluconate and so far it has served mainly as a pharmaceutical calcium source as in some well-known effervescent tablets. The outstanding characteristics of CLG, i.e high solubility, high bioavailability and neutral taste have resulted in new application such as fortification of products, thereby producing wide range of premium products.

TABLE 5
Properties of Calcium Lactate Gluconate (CLG)

| | | Solubility | Solubility | % of RDA in |
|---|---|---|---|---|
| Product | % Ca Content | [g/L water] | [g Ca/L water] | 100 ml* |
| CLG | 13 | 400 | 52 | 650 |

*RDA (Recommended Daily Allowances) of calcium equals 800 mg per day in the EU.

The solubility of Calcium Lactate Gluconate is synergistically enhanced to approx. 400 g/L water and well beyond that of the relatively well soluble single components calcium lactate (66 g/L) and calcium gluconate (35 g/L). The reason for this phenomenon of extremely high solubility is believed to be the ability of mixtures of lactate and gluconate ions to form meta-stable complexes with calcium ions in solution, which provides additional stability benefits in food and beverage applications. Calcium Lactate Gluconate provides a neutral taste, even at high concentrations. This is especially important for food applications, where high calcium levels must be obtained without negative influence on taste properties of the fortified product. It can be applied in the applications with a risk of calcium precipitation together with other components of the food such as CO₂ or tartaric acid in the carbonated beverages or grape juice.

Bioavailability of Calcium Lactate Gluconate: the effectiveness of the nutrient depends on its bioavailability, which means how well the human body absorbs and utilizes it for various functions occurring in the body. On an average, about 10 to 30% of the total calcium is only get absorbed from a mixed diet by healthy adults. Many different factors influence this level of availability, one being the type of salt providing calcium. Various scientific studies have shown that organic calcium salts outperform inorganic calcium sources such as calcium carbonate and calcium phosphate with regard to their relative bioavailability. Calcium Lactate Gluconate belongs to the group of highly bioavailable organic sources, proven by human and animal studies. Calcium Lactate Gluconate is primarily used in applications where solubility and clarity are important. Table 6 gives the list of commonly available calcium products and the amount of calcium available to human body from the various products.

TABLE 6
Calcium available to human body from commonly available Ca products

| | | % | | |
|---|---|---|---|---|
| | | availability | % | Total Ca |
| | | of inorganic | bioavailability | absorbed |
| | Consumption | Ca in | of Ca out of | by the |
| Ca products | (mg) | product | inorganic Ca | body (mg) |
| Ca Lactate | 1000 | 13 | High* | Max. |
| Gluconate | | | | |
| (CLG) | | | | |
| Ca Carbonate | 1000 | 40 | 10 | 40 |
| Ca Phosphate | 1000 | 39 | 10 | 39 |
| Ca Lactate | 1000 | 37 | 33 | 122 |
| Ca Citrate | 1000 | 21 | 50 | 105 |
| Ionic Ca | 1000 | 100 | 100 | 1000 |
| (Ca⁺⁺) | | | | |

*The Ca available in this supplement is in the organic form so available in maximum concentration.

Providing a safe, inexpensive bottled drinking water with a modest amount of calcium added is likely to be beneficial both in providing hydration and in improving calcium intake. The amount of calcium proposed for this product is modest 5 to 7 mg per 100 ml of water, contributing 10% of the current Recommended Dietary Intake for adults in India per liter of the hydration supplement. The proposed calcium source for this product is calcium lactate gluconate, which appears to be an ingredient with appropriate bioavailability and important physical characteristics for this use, such as high solubility and clarity.

### Functions of Copper in Human Body

Copper plays a significant role in human physiology. Copper is utilized by most cells as a component of enzymes (cuproenzymes) essential for many biochemical functions to occur normally in human body. Copper is a major component of catalytic center with Zinc superoxide dismutase in different redox reactions5 in the enzymes and thus its presence is important for normal physiological functions.

Functions of cupro-enzymes with oxidation-reduction activity and copper binding proteins in human are given in table 7.

TABLE 7
Function of cupro-enzymes in oxidation and reduction activity of human

| Cuproenzymes | Important functions |
|---|---|
| Amino acid oxidase | Amino acid metabolism i.e. Deamination |
| | of primary amines |
| Ceruloplasmin | Copper transport, conversion of iron into |
| | active form for transportation to various |
| | tissues. |
| Cytochrome-C oxidase | Energy production |
| Catechol oxidase | Synthesis of melanin |
| Dopamine-β monooxygenase | Noradrenaline synthesis |
| Protein-lysine 6-oxidase | Collagen and elastin cross-linking |
| Peptidylglycine | a-Amidation of neuropeptides |
| monooxygenase | |
| Superoxide dismutase | Protection of cell from free redical damage |
| Superoxide dismutase & lysyl | Strengthens connective tissues |
| oxidase | |
| Metallothionein | Radical scavenging, Metal transport |

Thus, vital role played by copper in the human body includes the following.
1. Formation of strong, flexible connective tissue and helps in the proper cross linking of collagen and elastin. Elastin helps to promote normal cardiovascular functions.
2. Production of collagen-the protein responsible for the structural formation of bone, cartilage, skin & tendon: prevents bone problems such as arthritis, osteoporosis, and rheumatoid arthritis.
3. Inhibition of free radical formation5.
4. Formation of adenosine triphosphate (ATP) the fuel to run the body6.
5. Production of hemoglobin thus helping to prevent anemia4.
6. Promotes the maintenance of good skin health and contributes to healthy respiration and general strength.
7. Contributes to healthy and normal cholesterol levels.
8. Excellent for immune system.

### How Much Copper Do Human Need?

The average adult human body generally contains 50-80 mg of copper. Recommended dietary allowance (RDA) for copper is shown in Table 8 as per The Food and Nutrition Board, Institute of Medicine, National Academies.

TABLE 8
Recommended dietary allowance (RDA) of copper for human

Copper, μg/day

| | | |
|---|---|---|
| Life stage | Male | Female |

Infants

| | | | |
|---|---|---|---|
| 0-6 | months | 200* | 200* |
| 7-12 | months | 220* | 220* |

Children

| | | | |
|---|---|---|---|
| 1-3 | years | 340 | 340 |
| 4-8 | years | 440 | 440 |
| 9-13 | years | 700 | 700 |
| 14-18 | years | 890 | 890 |

Adults

| | | | |
|---|---|---|---|
| 19-30 | years | 900 | 900 |
| 31-50 | years | 900 | 900 |
| 51-70 | years | 900 | 900 |
| >70 | years | 900 | 900 |

Pregnancy

| | | | |
|---|---|---|---|
| 14-18 | years | — | 1000 |
| 19-30 | years | — | 1000 |
| 31-50 | years | — | 1000 |

Lactating

| | | | |
|---|---|---|---|
| 14-18 | years | — | 1300 |
| 19-30 | years | — | 1300 |
| 31-50 | years | — | 1300 |

*is the Adequate Intakes and the rest are the Recommended Dietary Intakes as per given by FNB

Copper can be quite toxic when introduced into a living system in amounts that exceed the system's ability to render the metal safe through binding proteins or other means. Infants fed with cow milk based diets exclusively are more prone to develop copper deficiency than infants who are breast fed because of the low copper content of cow milk and limited absorption of this mineral in cow milk. While the milk stored and boiled in the copper utensils is sometimes toxic and in India this decline in copper found when copper vessels are avoided for these kinds of uses.

### Dietary Sources of Copper

Copper is found in number of food items, originating from both plants as well as animals. The plants or the plant parts normally rich in copper are nuts, seeds, whole grains, legumes, chocolates, cherries, dried nuts, root vegetables, cereals, peas, beans, tomatoes, milk, tea, potatoes while the food originating from animal source rich in copper are such as organ meat, chicken, seafood etc. Drinking water delivered through copper plumbing is a minor source of copper. It has long been established since the ancient times and the times of Ayurveda that drinking water when kept and taken from copper vessels is a cure for several ailments. For the same reason copper pipes were used for plumbing for delivering drinking water in many Middle East countries.

### Interest in Copper Fortified Product

Deficiency of copper causes:
Anemia
Nutropenia
Bone abnormalities in low birth weight in infants & in young children; fractures, osteoporosis, epiphyscal separation, fraying and cupping of metaphyses with spur formation and subperiostal new bone formation.

### Copper Ion Source

Copper in the cupric (Cu²⁺) state is believed to be readily absorbable and efficiently transported across cellular membranes. The ions also provide a unique product stabilizing residual anti microbial efficacy for beverages that retards the growth' of bacteria & other microorganisms including Salmonella, Fungi, Coliforms, Vibriocholera. This unique efficacy is residual and occurs during the growth of the microorganisms.

Copper intake tends to be low in Indian population due to certain reasons such as unawareness of the essentiality of this mineral amongst masses, improper diets, geographical imbalance and many more. Providing a safe, inexpensive bottled drinking water with a modest amount of copper added is likely to be beneficial in improving copper intakes. The amount of copper proposed for this product is modest 0.1 mg per 100 ml of water. The proposed copper ion source for this product is from Copper Sulphate as a source of Copper alongwith Ammonium Sulphate. Said Copper Sulphate is in the form of Copper Sulphate Pentahydrate. Further, it comprises Food grade Acidic compounds to maintain Copper in its potent ionic form.

Therefore, in order to prevent and bring down the occurrence of its deficiency diseases, it is necessary to supplement the daily food by providing additional quantities of the nutrients and this can be best done by way of fortification of a product of major consumption.

Present invention provides calcium fortifying composition for strength. Said Calcium Fortified for composition for strength comprises:
Calcium lactate gluconate,
Optionally supplemented by Calcium Chloride dihydrate
Copper Ion Source,
acidity regulator(330),
class II preservative (202)

The percentage amount of the ingredients in the composition is as follows:
about 85.1% to 93.50% by wt Calcium lactate gluconate;
optionally supplemented by about 6.5% to 7.2% by wt Calcium Chloride Dihydrate;
about 4.2% to 4.9259% by wt Copper Ion source;
about 0.6842% to 2% by wt class II preservative (202); and
about 0.8894% by wt citric acid, acidity regulator (330)

The composition of the present invention can be used as nutrient supplement in food items such as beverages, snacks, powered milk, etc. depending upon the nutrient requirement the composition of the present invention can be added in the food items.

In another embodiment the present invention provides a hydration supplement for human consumption. Said hydration supplement comprising the calcium fortifying composition along with a suitable food item.

Further, the amount of composition in the hydration supplement is 0.039% to 0.055% by weight or about 512 mg per liter such that the amount of the calcium source ingredient in the composition is 0.041% to 0.048% by weight or about 480 mg per liter and amount of copper in the composition is 0.00216% by weight or about 22 mg per liter.

Said hydration supplement is in liquid or semi/solid form. Further said hydration supplement may be a beverage such as aerated drink; treated water, etc.

In another embodiment the present invention provides treated water based hydration supplement or beverage fortified with Calcium composition. Said fortified treated water beverage comprises:
treated water prepared by the process of our co-pending patent application no. 1069/KOL/2010,
calcium fortifying composition comprising Calcium lactate gluconate, optionally supplemented by Calcium Chloride, copper ion source, acidity regulator (330), class II preservative (202).

Said fortified treated water beverage is a -neutral beverage and provides, 50 to 75 mg per litre Calcium, 1 mg per litre copper.

Table 9 shows the amounts of nutrients per liter of water

TABLE 9

| | | Active |
|---|---|---|
| | | Ingredients per |
| Ingredients | (in 1 liter) | liter |
| Calcium Lactate | 440 mg | 50 mg of Calcium |
| Gluconate ® | | |
| Calcium Chloride | 36.8 mg | 10 mg of Calcium |
| dihydrate | | |
| Nutribond ™ Copper | 21.5 mg | 1 mg of Cu |
| Ion | | |

TABLE 10

| | | | % of RDA | Safe | | Average Intake | | |
|---|---|---|---|---|---|---|---|---|
| | Quantity | RDA - | in one | Intake | | per day through | Nutrition | |
| | (per liter) | India | liter | level | Source | normal diet | Gap | Validation |
| Calcium | 60 mg | 600 mg* | 10% | 1500 mg | Expert | 350 mg | 50 mg | No risk of toxicity. 1500 mg per day |
| | | | | | group of | | | supplemental Ca has no adverse effect. |
| | | | | | vitamins & | | | A few studies involving human trials |
| | | | | | Minerals, | | | indicate that higher doses (of 2500 mg |
| | | | | | UK - | | | and above) might induce some |
| | | | | | 2003(Article | | | gastrointestinal side effects in some |
| | | | | | encl). | | | individuals. Higher Ca do not result |
| | | | | | | | | in the formation of stones while a |
| | | | | | | | | low Ca status may precipitate the |
| | | | | | | | | formation of stones |
| Copper | 1 mg | 2 mg | 50% | 10 mg | Expert | — | — | Exceeds the unstated upper limit |
| | | | | | group of | | | of 33% of RDA for ‘non supervised’ |
| | | | | | vitamins & | | | fortification as per PFA (Re Dr. |
| | | | | | Minerals, | | | Seshikeran). However, as per pfa |
| | | | | | UK - | | | standards elemental copper upto 1 mg |
| | | | | | 2003(Article | | | per liter is allowed for natural mineral |
| | | | | | encl). | | | water confirming that this level is safe |
| | | | | | | | | for consumption in water. Study reports |
| | | | | | | | | on Copper toxicity and storage in human |
| | | | | | | | | systems have established a safe upper |
| | | | | | | | | limit of 10 mg/day in a 60 kg adult |

*for pregnant and lactating mothers RDA is 1000 mg & for kids it is 500 mg and expected to go up. Regulation to come in from the next calender year.
Ca lactate gluconate - Proprietary product of Global Calcium
High solubility (the most soluble forms of organic Ca)
Neutral taste (retains the flavor profile of water while remaining colorless, without odor and microbiologically stable)
Excellent bioavailability. (maintains that solubility during transit through the small intestine, during which time it is exposed to passive diffusion sites, therefore maximizing Ca absorption).

Further the fortified treated water beverage of present invention has no added flavors or sweeteners to mask ingredient flavors.

The ingredients used in the water neutral beverage are selected in a manner as to be compatible with water such that they do not have any odour, the composition does not precipitate or reacts or sediments. Also, the shelf life of the elements has been so maintained in the composition that when the composition does not degrade when used with water. Said effects are the result of the synergistic effect among the ingredients of the composition.

The fortified treated water beverage of the present invention has been found to have beneficial results in restoring the strength in humans having deficiency of Calcium.

The invention further provides the process for the preparation of the calcium fortified treated water beverage. Said process comprises preparing treated water in accordance with the process disclosed in our co-pending application, followed by adding the Tata Water Plus composition taught in the present invention.

The limitation or disadvantage of this blend in terms of its restricted use to—
(i) Food products only as a means of fortification.

The limitation or disadvantage of this product relates to—
(i) Form of ingestion.

The invention will now be explained with the help of following examples. However, the scope of the invention should not be limited to these examples as the person skilled in the art can easily vary the proportion of the ingredients and combinations.

### EXAMPLE 1

### Preparation of the Calcium Fortifying Composition for Strength

Three different packages (two dry parts & one Liquid part) are prepared for the batch of 25000 liters.

First batch: 113475 kg of Dry Part 1 comprises:
11.0 kg of Calcium Lactate Gluconate
0.25 kg of Potassium Sorbate
0.0975 kg of Citric Acid

These ingredients are carefully weighed, blended and packaged in a sterile & dry container for use at the manufacturing facility. The specification sheets are maintained and the dry part 1 has to meet the specifications at the manufacturing location before these are used for the preparation of the concentrate.

Second batch: 1.14 kg of Dry Part 2 Comprises:
1.14 kg of Calcium Chloride.

The ingredient is carefully weighed and packaged in a sterile & dry container for use at the manufacturing facility. The specification sheets are maintained and the dry part 2 has to meet the specifications at the manufacturing location before these are used for the preparation of the concentrate.

Third batch: of Liquid part Comprises:
0.5375 kg of Copper Ion Source

The ingredient is carefully weighed and packaged in a sterile & dry container for use at the manufacturing facility. The specification sheets are maintained and the liquid part has to meet the specifications at the manufacturing location before these are used for the preparation of the concentrate.

### EXAMPLE 2

### Preparation of the Calcium Fortified Water Beverage with Calcium Fortifying Composition for Strength

A blending tank of 225 liters is taken for making the concentrate. 200 liters of treated water is made available in the blending tank. The dry parts 1 & 2 are added together. The stirring operations are carried out for 15 mins. The liquid part is added while the stirring is maintained. Treated Water is then added to make the the volume of concentrate in the tank to 225 liters. Dosing operation is then carried out to make the fortified Calcium product.

1. A calcium fortifying composition for strength for use in food products comprising:
Calcium lactate gluconate;
optionally supplemented by Calcium Chloride Dihydrate;
copper ion source;
class II preservative (202); and
acidity regulator (330),
wherein,
the amount of Calcium lactate gluconate is about 85.1% to 93.50% by weight;
the amount of Calcium Chloride Dihydrate is about 6.5% to 7.2% by weight;
the amount of copper ion source is about 4.2% to 4.9259% by weight
the amount of class II preservative (202) is about 0.6842% to 2% by weight; and
the amount of acidity regulator (330)is about 0.8894% by weight

2. The calcium fortifying composition as claimed in claim 1, wherein the ratio of the elemental Calcium to the elemental Copper is maintained at 60:1.

3. The calcium fortifying composition as claimed in claim 1, wherein the Calcium lactate gluconate is preferable in an amount of 85.9% or 440 mg per liter.

4. The calcium fortifying composition as claimed in claim 1, wherein the copper ion source is preferable in an amount of 4.2% or 21.5 mg per liter.

5. The calcium fortifying composition as claimed in claim 1, wherein the copper ion source is copper sulphate.

6. The calcium fortifying composition as claimed in claim 1, wherein the class II preservative (202) is potassium sorbate.

7. The calcium fortifying composition as claimed in claim 1, wherein the acidity regulator is citric acid.

8. The calcium fortifying composition as claimed in claim 1, wherein the class II preservative (202) is preferable in an amount of 2% or 10 mg per liter.

9. The calcium fortifying composition as claimed in claim 1, wherein the citric acid, acidity regulator (330) is preferable in an amount of 0.8% or 3.9 mg per liter.

10. A hydration supplement comprising the calcium fortifying composition for strength as claimed in claim 1, wherein an amount of the calcium source ingredient in the composition is 0.041% to 0.048% by weight or about 480 mg per liter and amount of copper source in the composition is 0.00216% by weight or about 22 mg per liter.

11. The hydration supplement as claimed in claim 10, wherein said supplement is liquid or semi solid or solid selected from the group comprising of aerated drinks, treated water, juices, etc.

12. A water beverage comprising treated water and calcium fortifying composition for strength, about 5.0 to 7.5 mg/100 ml elemental calcium, about 0.1 mg/100 ml elemental copper, and wherein the calcium fortifying composition comprises:
Calcium lactate gluconate;
optionally supplemented by Calcium Chloride Dihydrate;
copper ion source;
class II preservative (202); and
acidity regulator (330),
wherein
the amount of Calcium lactate gluconate is about 85.1% to 93.50% by weight;
the amount of Calcium Chloride Dihydrate is about 6.5% to 7.2% by weight;
the amount of copper ion source is about 4.2% to 4.9259% by weight
the amount of class II preservative (202) is about 0.6842% to 2% by weight; and
the amount of acidity regulator (330)is about 0.8894% by weight.

13. The water beverage as claimed in claim 12, wherein said water beverage comprises at least 6 mg /100 ml and up to 7.5 mg/100 ml elemental calcium.

14. The water beverage as claimed in claim 12, wherein said water beverage is neutral, colourless, odourless and requires no added flavor or sweeteners to mask ingredients.

15. A process of preparing the water beverage fortified with calcium fortifying composition for strength comprising the steps of:
effective treatment and sterilization of source water;
fortifying said treated water with the calcium fortifying composition comprising:
Calcium lactate gluconate;
optionally supplemented by Calcium Chloride Dihydrate;
copper ion source;
class II preservative (202); and
acidity regulator (330),
wherein
the amount of Calcium lactate gluconate is about 85.1% to 93.50% by weight;
the amount of Calcium Chloride Dihydrate is about 6.5% to 7.2% by weight;
the amount of copper ion source is about 4.2% to 4.9259% by weight
the amount of class II preservative (202) is about 0.6842% to 2% by weight;
and
the amount of acidity regulator (330)is about 0.8894% by weight.
